(19) United States
(12) Patent Application Publication
(10) Pub. No.: US 2022/0266071 A1
(43) Pub. Date: Aug. 25, 2022

(54) THREE-DIMENSIONAL TEST FIXTURE AND METHODS FOR TESTING RESPIRATORS

(71) Applicant: Global Safety First, LLC, Sea Girt, NJ (US)

(72) Inventor: John A. SCHWIND, Manasquan, NJ (US)

(21) Appl. No.: 17/182,959

(22) Filed: Feb. 23, 2021

(51) Int. Cl. A62B 27/00; G01N 15/08

(52) U.S. Cl. CPC A62B 27/00; G01N 15/0806; G01N 15/082; G01N 2015/084

(57) ABSTRACT

Implementations of the disclosure relate to apparatus and methods for supporting and testing respirators during testing operations. In one aspect, the respirators are tested to determine if the respirators meet a testing standard. In one implementation, a test fixture for supporting respirators during testing operations includes a fixture. The fixture includes a base portion, and a first protrusion including one or more first mounting surfaces disposed above the base portion. The fixture includes a second protrusion including one or more second mounting surfaces disposed above the base portion, and a backside surface that opposes the first protrusion and the second protrusion. The fixture includes a cavity disposed between the first protrusion and the second protrusion, and an aperture extending from the cavity and to the backside surface.

### BACKGROUND

### Field

The disclosure relates to apparatus and methods for supporting and testing respirators during testing operations. In one aspect, the respirators are tested to determine if the respirators meet a testing standard.

### Description of the Related Art

Test fixtures and methods for testing respirators fail to account for the issue that not all respirators have a traditional cup-like shape. For example, testing fixtures fail to account for the actual configuration of a respirator on a human face during use of the respirator. As another example, testing respirators while disposed on a human face of a human can involve additional human error during the testing. Hence, testing of the respirator may not accurately simulate actual use of the respirator and can lead to inaccurate results.

Therefore, there is a need for improved test fixtures and methods for testing respirators that facilitate simulating actual configuration of the respirator on a human face and reducing human error.

### SUMMARY

Implementations of the disclosure relate to text fixtures and methods for supporting and testing respirators during testing operations. In one aspect, the respirators are tested to determine if the respirators meet a testing standard.

In one implementation, a test fixture for supporting respirators during testing operations includes a base portion having a frontside surface and a backside surface. The test fixture includes a first protrusion coupled to the base portion and having one or more first mounting surfaces disposed above the frontside surface of the base portion. The test fixture includes a second protrusion coupled to the base portion and having one or more second mounting surfaces disposed above the frontside surface of the base portion. The test fixture includes a cavity disposed between the first protrusion and the second protrusion, and an aperture formed in the base extending from the cavity and to the backside surface.

In one implementation, a method of testing respirators includes sealing a respirator on a fixture. The sealing the respirator on the fixture includes covering a cavity of the fixture with the respirator, contacting the respirator to a plurality of mounting surfaces of the fixture, and pressing an adhesive integrated as part of the respirator against the plurality of mounting surfaces of the fixture. The method includes enclosing the respirator and the fixture within a housing structure that includes an inlet hole and an outlet hole. The method includes flowing an air stream through the inlet hole, through the respirator, and through the outlet hole. The air stream flowing through the inlet hole contains an aerosol challenge. The method includes determining that the respirator meets a testing standard based on a metric of an amount of the aerosol challenge penetrating the respirator.

In one implementation, a method of testing respirators includes sealing a respirator on a fixture. The sealing the respirator on the fixture includes contacting the respirator to a plurality of mounting surfaces of the fixture, pressing an adhesive of the respirator against the plurality of mounting surfaces of the fixture, and pressing a first portion of the adhesive into a second portion of the adhesive. The method includes enclosing the respirator and the fixture within a housing structure that includes an inlet hole and an outlet hole. The method includes flowing an air stream through the inlet hole, through the respirator, and through the outlet hole. The air stream flowing through the inlet hole contains an aerosol challenge. The method includes determining an upstream particle concentration of the aerosol challenge that is upstream of the respirator, and determining a downstream particle concentration of the aerosol challenge that is downstream of the respirator. The method includes determining a particle ratio of the downstream particle concentration relative to the upstream particle concentration, and determining if the particle ratio is 0.05 or less.

### BRIEF DESCRIPTION OF THE DRAWINGS

So that the manner in which the above-recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic backside view of a respirator in a pull-apart storage structure, according to one implementation.

FIG. 2 is a schematic backside view of a cover sheet, according to one implementation.

FIG. 3 is a schematic isometric front view of a test fixture for supporting respirators during testing operations, according to one implementation.

FIG. 4 is a schematic isometric back view of the test fixture shown in FIG. 3, according to one implementation.

FIG. 5 is a schematic front view of the test fixture shown in FIG. 3, according to one implementation.

FIG. 6 is a schematic sectional view of the test fixture, taken along Section A- -A shown in FIG. 3, according to one implementation.

FIG. 7 is a schematic isometric view of a housing structure for selectively enclosing the test fixture, according to one implementation.

FIG. 8 is a schematic view of a system for testing respirators, according to one implementation.

FIG. 9 is a schematic view of a method of testing respirators, according to one implementation.

To facilitate understanding, identical reference numerals have been used, where possible, to designate identical elements that are common to the figures. It is contemplated that elements disclosed in one implementation may be beneficially utilized on other implementations without specific recitation.

### DETAILED DESCRIPTION

Implementations of the disclosure relate to test fixtures and methods for testing respirators. In one aspect, the respirators are tested to determine if the respirators meet a testing standard.

It is to be noted that relational terms recited herein, such as “above,” “below,” “upwardly,” and “downwardly” are purely relational and are included for clarity and understanding of the subject matter. As an example, a first item that is “above” a second item can be “above” the second item along the horizontal X-Y plane that is perpendicular to gravitational forces without being “above” the second item along the Z-axis that is parallel to gravitational forces.

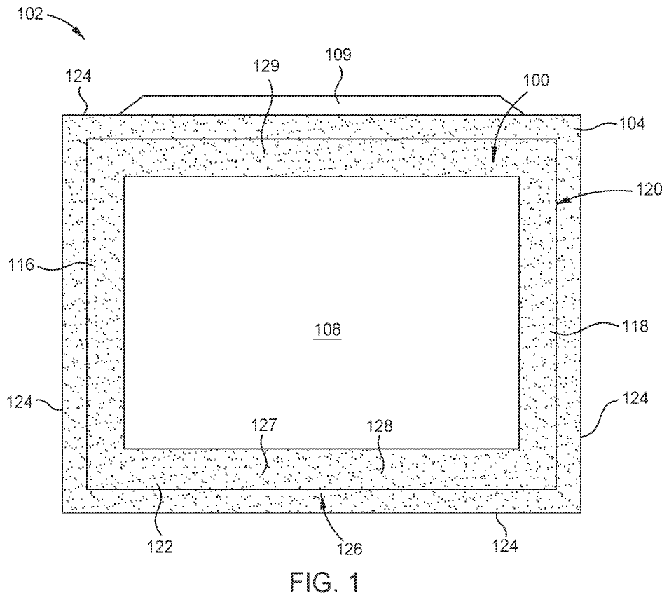

FIG. 1 is a schematic backside view of a respirator 100 in a pull-apart storage structure 102, according to one implementation. The respirator 100 is a filtration device that is configured to be worn on the face of a human user to filter air being inhaled through the nose and/or mouth of the human user. In the implementation depicted in FIG. 1, the respirator 100 is configured to filter air being both inhaled and exhaled through the nose and mouth of the human user. The respirator 100 filters particles of, for example, dust, smoke, sand, viruses, bacteria, and/or germs to significantly reduce the number of particles inhaled by the user through the respirator 100. A first sealing sheet (not shown in FIG. 1) and a second sealing sheet 104 form the pull-apart storage structure 102 to seal the respirator 100 in the pull-apart storage structure 102 (which is air and moisture impermeable) prior to use. The respirator 100 is sealed between the first sealing sheet and the second sealing sheet 104 of the pull-apart storage structure 102 prior to use of the respirator 100.

To facilitate filtration of particles, the respirator 100 includes one or more layers of filtration media 108, which may be either dry or moistened. If filtration media 108 is to be used moistened, the respirator 100 is stored in a pre-moistened condition. The respirator 100 is moistened with water, either alone or in combination with other materials. The respirator 100 may also be moistened with aloe, glycerin, and/or corn syrup, alone or in desired combinations. The respirator 100 need not be moistened, and can be used and stored in a dry condition. In one embodiment, which can be combined with other embodiments, the respirator 100 has a filter efficiency of at least about 95% when tested in accordance with National Institute for Occupational Safety and Health (NIOSH) meeting N95 criteria. In one example, at least about 95% of charge neutralized particles having an approximate diameter of 0.3 microns (micrometers) are removed from air flowing through the respirator 100 at a flow rate within a range of about 80 liters of air per minute to about 90 liters of air per minute, with a total filter load of at least about 200 milligrams of the particles. In one embodiment, the flow rate is within a range of about 81 liters of air per minute to about 89 liters or air per minute. In one example, the flow rate is about 85 liters of air per minute.

The present disclosure contemplates that the respirator 100 can include a transparent face shield above the filtration media 108. The transparent face shield can include an adhesive similar to the adhesive 120 for pressing and sealing the transparent face shield to the human user's forehead. The transparent face shield can shield and protect the human user's eyes.

The filtration media 108 may be constructed of any single or multi-layered material suitable for air filtration, such as paper or a fibrous material, wet laid glass, melt blown synthetics or other suitable material. The respirator 100 is rectangular-shaped, as shown in FIG. 1. The present disclosure contemplates that other shapes may be used, provided that the respirator 100 is sized sufficiently to allow the human user to breathe when in use. For example, the respirator 100 may be more triangular shaped.

An adhesive 120 is disposed in a rectangular ring-shaped pattern along an outer periphery of the respirator 100. The adhesive 120 is a pressure-sensitive adhesive. The adhesive 120 is of the type suitable for adhesion to human skin and releasable from the skin without injury. In one embodiment, the adhesive 120 is hydrophobic to facilitate attachment to human skin even in the presence of moisture, from sweat or the like. The adhesive 120 may be disposed directly on the filtration media 108 of the respirator 100, as is shown in FIG. 1.

During use, the adhesive 120 is exposed (such as by peeling a sheet from the adhesive 120). The respirator 100 is then applied to the face, with the respirator 100 being bent to fit (e.g., conform) and seal the respirator 100 to the chin, cheeks, and nose of the human user. The adhesive 120 includes a first vertical section 118 and a second vertical section 116, which are pressed against the cheeks to adhere the vertical sections 116, 118 to the cheeks. The vertical sections 116, 118 of the respirator 100 adjusts to the curvature and contour of the human face.

The adhesive 120 includes a first horizontal section 122, which is bent under and/or pressed and sealed to the chin, and secured to the chin using the adhesive 120. The adhesive 120 includes a second horizontal section 129, which is bent about the bridge of the nose of the human user and pressed into the nose and the cheeks to secure the respirator 100 to the nose and cheeks using the adhesive 120. The adhesive 120 is used to seal an entirety of the outer periphery of the respirator 100 to the user's face.

During sealing of the first and second vertical sections 118, 116 and the first and second horizontal sections 122, 129 to the chin, cheeks, and nose of the human user, a portion of the respirator 100 can become disposed at a gap from the face of the human user. Two portions of the adhesive 120 are pressed together adjacent the portion of the respirator 100 to create a seal such that air cannot flow through the gap between the respirator 100 and the face. In one embodiment, the gap is disposed adjacent a lower end 126 of the respirator. In such an embodiment, a first portion 127 of the first horizontal section 122 is pressed into a second portion 128 of the first horizontal section 112 to create a seal adjacent the gap.

The first sealing sheet and the second sealing sheet 104 together form the pull-apart storage structure 102 for storing the respirator 100 until use. An outer peripheral edge 124 of each of the first sealing sheet and the second sealing sheet 104 is sealingly attached to the outer peripheral edge 124 of the other of the first sealing sheet and the second sealing sheet 104 during manufacturing. The first and second sealing sheets may be sealed together on the outer peripheral edges 124 thereof by any appropriate sealing means, including pressure-sensitive, heat activated, or other adhesive, hot-glue, sonic welding, etc., provided that the sheets may be pulled apart with physical force of a human user, such as a child. The first and second sealing sheets are constructed of a translucent plastic, however any appropriate material may be used. One or both of the first and second sealing sheets includes a pull tab 109 that facilitates the first and second sealing sheets to be pulled apart and separated to allow removal of the respirator 100 from the pull-apart storage structure 102.

One of the first and second sealing sheets which interfaces with the adhesive 120 (which is the second sealing sheet 104 in the implementation of FIG. 1) is adapted to enable the adhesive 120 to be exposed once the pull-apart storage structure 102 is opened by separating the first sealing sheet and the second sealing sheet 104. The second sealing sheet 104 that interfaces with the adhesive 120 functions as a cover sheet for the adhesive 120. The second sealing sheet 104 is coupled to the adhesive 120 using a release material coated on the second sealing sheet 104. Any appropriate release material that releases from adhesive 120 may be used to coat the second sealing sheet 104, or the second sealing sheet 104 may be constructed entirely of the release material, provided that the second sealing sheet 104 is still capable of being attached to the first sealing sheet to form the pull-apart storage structure 102.

The respirator 100 can include a horizontal flexible strip, such as a thin metal strip, to facilitate securing the respirator 100 to the bridge of the nose of the human user. In one embodiment, which can be combined with other embodiments, the second horizontal section 129 is omitted from the adhesive and the horizontal flexible strip is used.

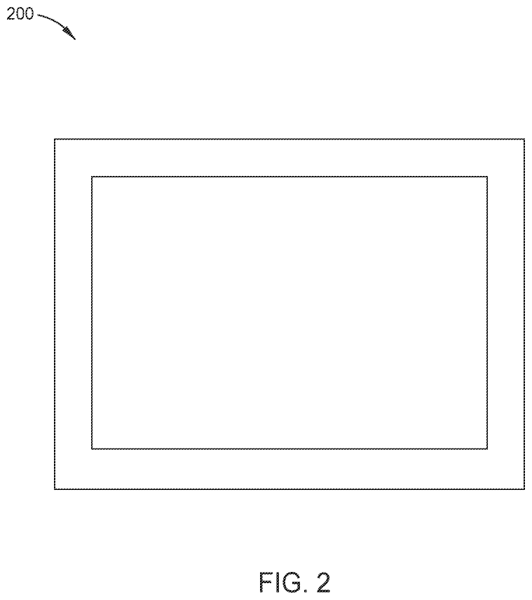

FIG. 2 is a schematic backside view of a cover sheet 200, according to one implementation. The cover sheet 200 is separate from the first and second sealing sheets of FIG. 1. The cover sheet 200 covers the adhesive 120. The cover sheet 200 has a rectangular ring-shaped pattern that aligns with the rectangular pattern of the adhesive 120. The cover sheet 200 is pulled from the adhesive 120 to expose the adhesive 120 for pressing the adhesive 120 to the face of the human user. The cover sheet 200 may be attached (such as by using water-proof adhesive) to the second sealing sheet 104 that interfaces with the adhesive 120. After the first and second sealing sheets are pulled apart, the respirator 100 can be left attached to the second sealing sheet 104 by the cover sheet 200. The respirator 100 can then be pulled from the second sealing sheet 104, causing the cover sheet 200 to separate from the adhesive 120, thereby exposing the adhesive 120 and rendering the respirator 100 ready for use. The present disclosure contemplates that the cover sheet 200 may not be initially adhered to the second sealing sheet 104 such that the cover sheet 200 is adhered to the adhesive 120 but not the second sealing sheet 104 after the first and second sealing sheets are separated. The human user may then separate the cover sheet 200 from the adhesive 120 to expose the adhesive 120.

The present disclosure contemplates that one or more of the corners of the adhesive 120, one or more of the corners of the respirator 100, and/or one or more of the corners of the cover sheet 200 can include radii, chamfers, tapers, and/or fillets.

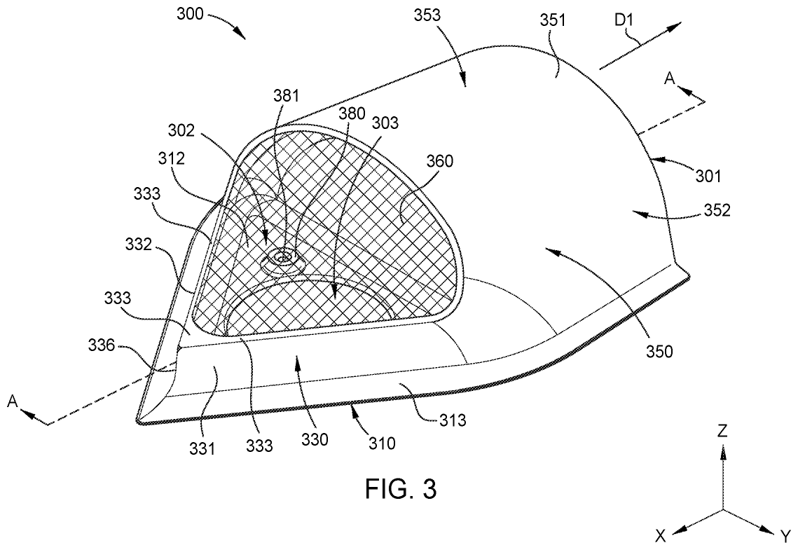

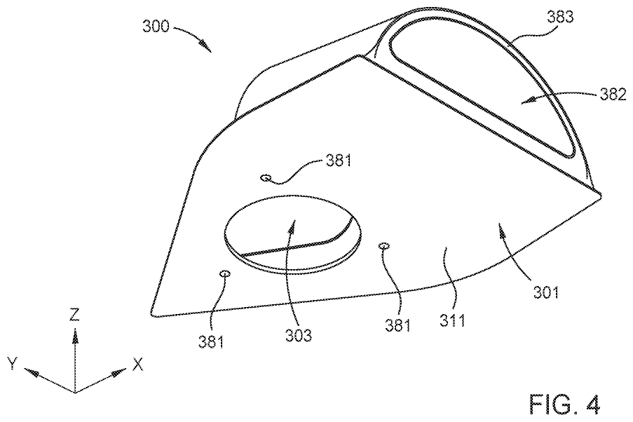

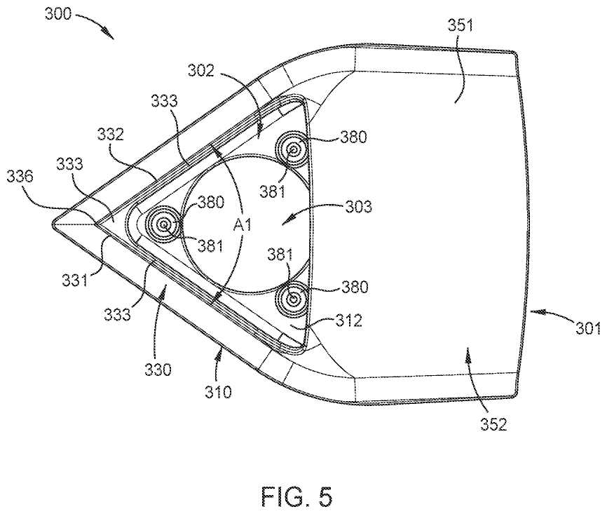

FIG. 3 is a schematic isometric front view of a test fixture 300 for supporting respirators during testing operations, according to one implementation. FIG. 4 is a schematic isometric back view of the test fixture 300 shown in FIG. 3, according to one implementation. FIG. 5 is a schematic front view of the test fixture 300 shown in FIG. 3, according to one implementation.

The test fixture 300 includes a 3D-body 301. The 3D-body 301 includes a base portion 310, a first protrusion 330 coupled to and protruding from the base portion 310, and a second protrusion 350 coupled to and protruding from the base portion 310. The 3D-body 301 includes one or more first mounting surfaces. The one or more first mounting surfaces are a part of the first protrusion 330. The one or more first mounting surfaces include a first vertical surface 331 (of the first protrusion 330) that extends upwardly relative to the base portion 310, and a second vertical surface 332 (of the first protrusion 330) that extends upwardly relative to the base portion 310. The present disclosure contemplates that the first and second vertical surfaces 331, 332 may be completely vertical (e.g., parallel to the Z-axis), or may be at an acute angle relative to the Z-axis, such as at an acute angle that is 30 degrees or less. The first vertical surface 331 and the second vertical surface 332 intersect at an apex 336 to form an acute angle Al between the first vertical surface 331 and the second vertical surface 332. The first vertical surface 331 and the second vertical surface 332 are disposed above the base portion 310. The first protrusion 330 also includes one or more horizontal surfaces 333 (three are shown) disposed above the base portion 310 and above the first and second vertical surfaces 331, 332. The one or more first surfaces include a base surface 313 (of the base portion 310) that tapers or curves downwardly away from the first protrusion and the second protrusion. The first protrusion 330 is triangular in shape and the second protrusion 350 is arced in shape.

The second protrusion 350 includes one or more second mounting surfaces disposed above the base portion 310. The one or more second mounting surfaces include an arcuate surface 351 that arcs downward toward the base portion 310 on two sides 352, 353 of the arcuate surface 351. The arcuate surface 351 arcs in the X-Y plane. The arcuate surface 351 curves downwardly in a direction D1 away from the cavity 302 and away from the first protrusion 330. The direction D1 is parallel to the X-axis. The 3D-body 301 includes a backside surface 311 that opposes the first protrusion 330 and the second protrusion 350. The backside surface 311 is a part of the base portion 310. The 3D-body 301 also includes a cavity 302 disposed between the first protrusion 330 and the second protrusion 350, and an aperture 303 extending from the cavity 302 and to the backside surface 311. The base portion 310 also includes a frontside surface 312 that opposes the backside surface 311. The aperture 303 extends between the frontside surface 312 and the backside surface 311.

In one embodiment, the 3D-body 301 is formed of a single contiguous mass of material that includes the base portion 310, the first protrusion 330, and the second protrusion 350. The 3D-body 301 can be formed using three-dimensional printing, casting, injection molding, vacuum molding, or other suitable technique. In one example, the 3D-body 301 is formed of a polymeric material, such as a plastic material.

The test fixture 300 also includes a support structure 360 that spans the opening of the cavity 302 to support the portions of the respirator that are not in contact with the test fixture 300 during testing of the respirator. In the implementation shown, the support structure 360 is a wire mesh that connects on the frontside surface 312. In one embodiment, the support structure 360 includes one or more support beams that extend across the cavity 302 and are integrally formed with the body of the 3D-body 301. The support structure 360 is omitted from the view in FIG. 5.

The 3D-body 301 is three-dimensional, the one or more first mounting surfaces (including the base surface 313, the first vertical surface 331, and the second vertical surface 332) are three-dimensional, and the one or more second mounting surfaces (including the arcuate surface 351) are three-dimensional. The one or more mounting surfaces and the one or more second mounting surfaces extend along the X-axis, the Y-axis, and the Z-axis.

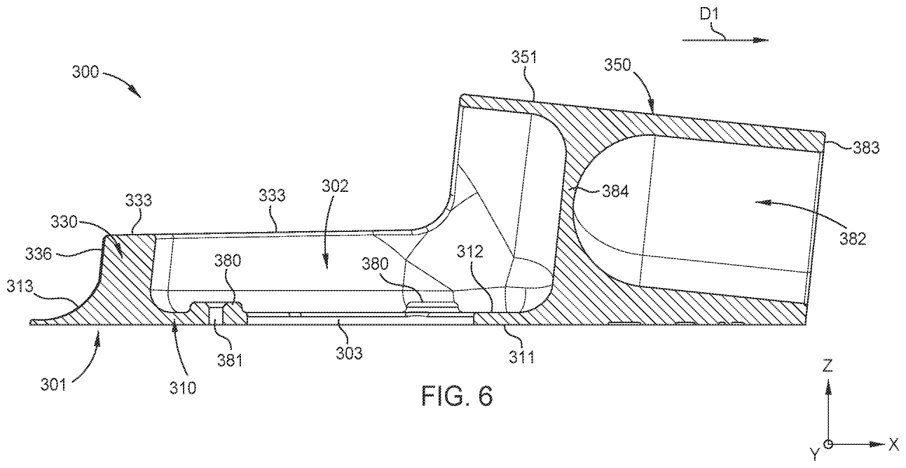

FIG. 6 is a schematic sectional view of the test fixture 300, taken along Section A- -A shown in FIG. 3, according to one implementation. The Section A- -A is parallel to the X-axis and the direction D1. The support structure 360 is not shown in FIG. 6. The 3D-body 301 includes one or more bosses 380 (three are shown in FIG. 5) that protrudes above the frontside surface 312. Each of the one or more bosses 380 includes an opening 381 that extends through each respective boss 380. The opening 381 through the boss 380 can be utilized to secure the 3D-body 301 to a housing structure using a fastener (further described below). The 3D-body 301 includes a second cavity 382 formed in an end 383 of the 3D-body 301 that opposes the apex 336. A wall 384 is disposed between the cavity 302 and the second cavity 382.

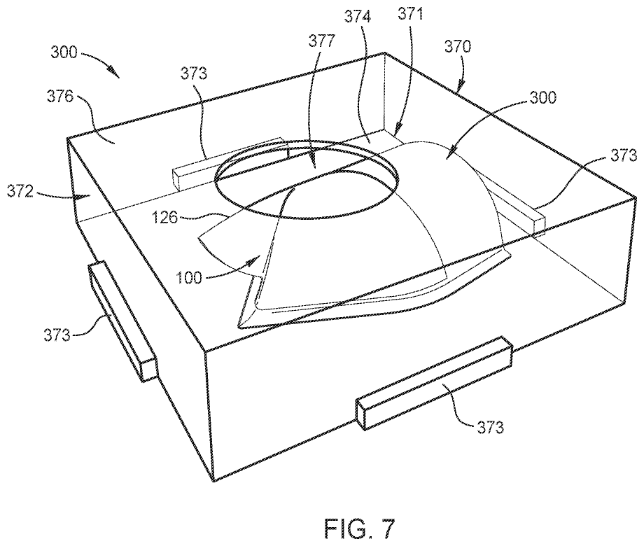

FIG. 7 is a schematic isometric view of a housing structure 370 for selectively enclosing the test fixture 300, according to one implementation. The 3D-body 301 is sealingly coupled to the housing structure 370, for example using adhesive or a gasket. In one example, the 3D-body 301 is coupled to the housing structure 370 using fasteners disposed though the openings 381 formed in the bosses 380 (shown in FIG. 6). The housing structure 370 may be opened or removed from the 3D-body 301 to allow the respirator 100 to be mounted to or removed from the test fixture 300. In one embodiment, the respirator 100 is configured to be worn on a face of an adult, and the respirator 100 has a surface area size of 200 square centimeters or greater, such as 238 square centimeters. In one embodiment, the respirator 100 is configured to be worn on a face of a child, and the respirator 100 has a surface area size of 150 square centimeters or greater.

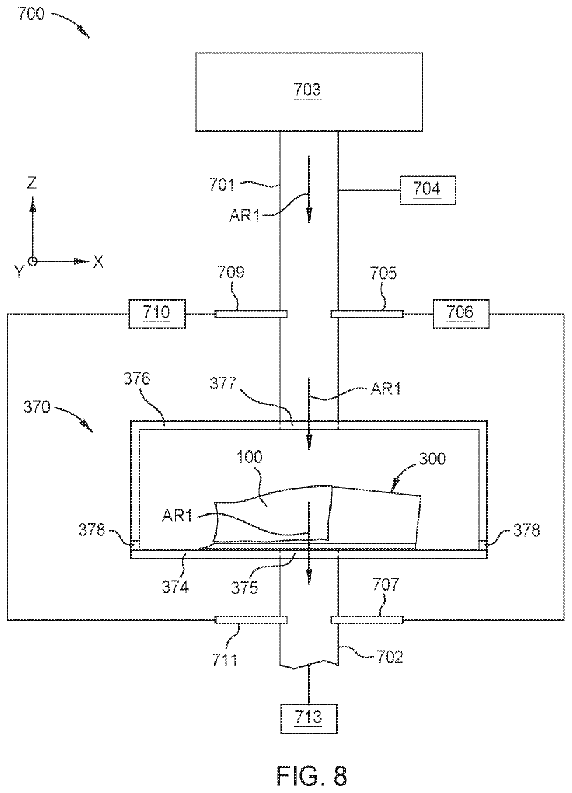

The housing structure 370 includes a first piece 371 and a second piece 372. The first piece 371 may be removed from the second piece 372 to allow the respirator 100 to be mounted to or removed from the test fixture 300. A seal 378 (shown in FIG. 8), such as a gasket, is disposed between the first piece 371 and the second piece 372 to provide prevent leakage therebetween. The first piece 371 includes a plurality of guide members 373 (four are shown) to guide the second piece 372 and facilitate alignment and sealing the first piece 371 and the second piece 372.

The first piece 371 includes a first wall 374 having an outlet hole 375 (shown in FIG. 8), and the second piece 372 includes a second wall 376 that opposes the first wall 374 and has an inlet hole 377. The 3D-body 301 is fixed and sealed (such as by using an adhesive) to the first wall 374. The first vertical section 118 of the adhesive 120 is folded about and adhered to the first vertical surface 331 or the base surface 313. The second vertical section 116 of the adhesive 120 is folded about and adhered to the second vertical surface 332 or the base surface 313. The first horizontal section 112 of the adhesive 120 is folded about the apex 336 and is at least partially adhered to itself (for example the first portion 127 can be adhered to the second portion 128). The first horizontal section 112 of the adhesive 120 is also folded about and adhered at least partially to the base surface 313, the first vertical surface 331, and/or the second vertical surface 332. The second horizontal section 129 of the adhesive 120 is folded about and adhered to the arcuate surface 351.

FIG. 8 is a schematic view of a system 700 for testing respirators, according to one implementation. The system 700 includes the housing structure 370 having the test fixture 300 disposed therein, a fan 703, an aerosol generator 704, and a particle detector 706. An inlet line 701 couples the fan 703 to the inlet hole 377 of the housing structure 370. An outlet line 702 couples the outlet hole 375 of the housing structure 370 to an exhaust 713. The fan 703 provides an air stream AR1 that flows into the housing structure 370, and passes through a respirator 100 disposed on the test fixture 300 and out the outlet line 703 to the exhaust 713. The aerosol generator 704 is also coupled to the inlet line 701. The aerosol generator 704 introduces an aerosol challenge into the air stream AR1 within the inlet line 701 that enters the housing structure 370 through the inlet hole 377. Within the housing structure 370, the flow passes through the respirator 100, along with an amount of aerosol that penetrates the respirator (e.g., is not filtered out). The air flow, along with the amount of aerosol that has penetrated through the filtration media 108, flow into the cavity 302 through the filtration media 108, exits the aperture 303 of the 3D-body 301, and exits the outlet hole 375 of the housing structure 370 into the outlet line 703.

The system 700 includes an upstream particle probe 705 coupled to the particle detector 706 to measure and determine an upstream particle concentration of the aerosol challenge within the air flow AR1 that is upstream of the respirator 100. The system 700 also includes a downstream particle probe 707 coupled to the particle detector 706 to determine a downstream particle concentration of the aerosol challenge within the air stream that is downstream of the respirator 100. Optionally, separate particle detectors 706 may be coupled to each of the probes 705, 707. The system 700 also includes an upstream pressure probe 709 and a downstream pressure probe 711 coupled to a pressure sensor 710. The pressure sensor 710 is utilized to determine the pressure drop across the respirator 100. Optionally, separate pressure 710 sensors may be coupled to each of the probes 710, 711.

The inlet hole 377 of the housing structure 370, the cavity 302, the aperture 303 of the 3D-body 301, and the outlet hole 375 of the 3D-body 301 may be at least partially vertically aligned with each other along the Z-axis. The inlet hole 377, the aperture 303, and the outlet hole 375 may be circular in shape. Other shapes may be used, such as a rectangular shape or a square shape. Aspects of the test fixture 300 facilitate testing the effectiveness of the adhesive seal between the respirator 100 and the test fixture 300 while the respirator 100 is conformed to a shape that is similar to a shape of the respirator 100 if the respirator 100 were to be conformed to a human face.

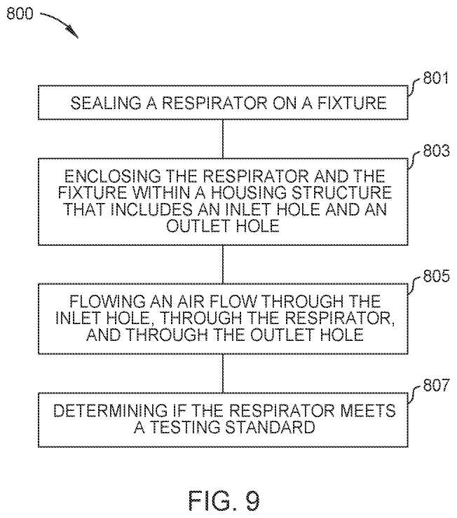

FIG. 9 is a schematic view of a method 800 of testing respirators, according to one implementation. The method 800 begins at operation 801 by sealing a respirator on a fixture. A cover sheet (such as the cover sheet 200 shown in FIG. 2) can be separated from the respirator prior to the sealing the respirator on the fixture. The sealing the respirator on the fixture includes covering a cavity of the fixture with the respirator. In some examples, covering the cavity of the fixture with the respirator includes bending the respirator from a substantially flat orientation to a three dimensional shape. The respirator is bent to conform with one or more first mounting surfaces of the fixture and with one or more second mounting surfaces of the fixture. In one embodiment, a support structure spans the opening of the cavity to support center portions of the respirator that are not in contact with the fixture. The support structure includes a wire mesh or one or more support beams that are integrally formed with the fixture. In one embodiment, the one or more first mounting surfaces include a first vertical surface extending upwardly relative to a base portion of the fixture, and a second vertical surface extending upwardly relative to the base portion. The first vertical surface and the second vertical surface intersect at an apex to form an acute angle between the first vertical surface and the second vertical surface. In one embodiment, the one or more first mounting surfaces include a base surface of a base portion of the fixture. The base surface tapers or curves downwardly.

The sealing the respirator on the fixture also includes contacting an adhesive of the respirator onto the one or more first mounting surfaces and the one or more second mounting surfaces of the fixture. The adhesive effectively seals the respirator to the mounting surfaces of the fixture. The seal manner advantageously allows the aerosol challenge to both test the effectiveness of the adhesive seal along with the effectiveness of the filtration media 108 of the respirator 100.

In one embodiment, the respirator includes a transparent face shield, and the sealing the respirator on the fixture includes bending the transparent face shield about the one or more second mounting surfaces, and pressing an adhesive of the transparent face shield onto the second mounting surfaces. The sealing the respirator on the fixture also includes, after the bending the respirator about the one or more first mounting surfaces and about the one or more second mounting surfaces, and after the pressing the adhesive of the respirator onto the one or more first mounting surfaces and the one or more second mounting surfaces: pressing a first portion of the adhesive into a second portion of the adhesive.

At operation 803, the respirator and the fixture are enclosed within a housing structure. The housing structure includes an inlet hole and an outlet hole.

At operation 805, an aerosol challenge is introduced to an air flow passing through the inlet hole, through the respirator, and through the outlet hole. The aerosol challenge includes particles of a composition selected according to the testing standard, such as the testing standard of NIOSH 95. The aerosol challenge, in one example, includes salt particles having a diameter of about 0.3 microns. Other particles may alternatively or additionally be included in the aerosol challenge, such as dust particles or sand particles. The air flow passes through the respirator at a flow rate within a range of 80 liters of air per minute to 90 liters of air per minute, such as 81 liters of air per minute to 89 liters of air per minute. In one embodiment, the flow rate is about 85 liters of air per minute.

At operation 807, it is determined if the respirator meets a testing standard. In one example, the testing standard is an inhalation standard. As utilized herein, testing standard means an industry accepted or governmental standard, such as NIOSH, Occupational Safety and Health Administration (OSHA), Institute for Environmental Sciences (IES) or other similar trade or governmental organization. In one embodiment, the testing standard is NIOSH N95. The operation 807 of determining if the respirator meets the testing standard includes determining an efficiency of particle filtration of the respirator. In one example, determining an efficiency of the respirator includes determining an upstream particle concentration of aerosol challenge within the air stream that is upstream of the respirator, and determining a downstream particle concentration of the aerosol challenge within the air stream that has passed through the filtration media and is downstream of the respirator. The determining if the respirator meets the testing standard also includes determining a particle ratio of the downstream particle concentration relative to the upstream particle concentration (e.g., filtration efficiency), and determining if the particle ratio is 0.05 or less (e.g., has an efficiency of 95% or greater). If the particle ratio is 0.05 or less, then the testing standard is met. If the particle ratio is 0.05 or less, then the respirator has a filter efficiency of 95% or more. In one embodiment, each of the upstream particle concentration and the downstream particle concentration is a concentration of particles having a diameter of 0.3 microns.

The determining if the respirator meets the testing standard also includes determining an upstream pressure of the aerosol stream that is upstream of the respirator, determining a downstream pressure of the aerosol stream that is downstream of the respirator, and determining a pressure difference between the upstream pressure and the downstream pressure. The determining if the respirator meets the testing standard also includes determining if the pressure difference is 30 mmHg or less, such as 25 mmHg or less. If the pressure difference is 30 mmHg or less, such as 25 mmHg or less, then the testing standard is met and resistance specifications are met for the respirator.

The aspects of operations 805 and 807 can be conducted for a test time that is about 5 minutes. As an example, the particle ratio and the pressure difference can be continuously determined throughout the test time of about 5 minutes. A full load test can be conducted to fully load the respirator, for which operations 805 and 807 can be conducted for a test time that is within a range of about 20 minutes to about 25 minutes. For the full load test, the pressure difference may exceed 30 mmHg.

Following operation 807, the respirator can be removed from the housing structure, and operations 801, 803, 805, and 807 can be conducted for a second respirator.

Benefits of the present disclosure include a fixture for testing respirators that simulates the respirator being sealed to a human face without actually sealing the respirator to a human face during testing; more accurate filter efficiency testing results and filter resistance testing results; less human error during testing of respirators; and a fixture that is easy and less costly to produce, and easy to use. Beneficially, the manner of testing also includes testing the adhesive seal to the fixture, which emulates the effectiveness of the seal of the adhesive, and thus the respirator itself, to a human user. It is contemplated that one or more of the aspects disclosed herein may be combined. Moreover, it is contemplated that one or more of the aspects may include some or all of the aforementioned benefits. As an example, the present disclosure contemplates that one or more aspects, features, components, and/or properties of one or more of the respirator 100, the pull-apart storage structure 102, the cover sheet 200, the test fixture 300, the 3D-body 301, the system 700, and/or the method 800 may be combined.

It will be appreciated by those skilled in the art that the preceding embodiments are exemplary and not limiting. It is intended that all modifications, permutations, enhancements, equivalents, and improvements thereto that are apparent to those skilled in the art upon a reading of the specification and a study of the drawings are included within the scope of the disclosure. It is therefore intended that the following appended claims may include all such modifications, permutations, enhancements, equivalents, and improvements. The present disclosure also contemplates that one or more aspects of the embodiments described herein may be substituted in for one or more of the other aspects described. The scope of the disclosure is determined by the claims that follow.

We claim:

1. A test fixture for supporting respirators during testing operations, comprising:
a base portion having a frontside surface and a backside surface,
a first protrusion coupled to the base portion and comprising one or more first mounting surfaces disposed above the frontside surface of the base portion,
a second protrusion coupled to the base portion and comprising one or more second mounting surfaces disposed above the frontside surface of the base portion,
a cavity disposed between the first protrusion and the second protrusion, and
an aperture formed in the base portion extending from the cavity and to the backside surface.

2. The test fixture of claim 1, wherein the one or more first mounting surfaces are three-dimensional, and the one or more second mounting surfaces are three-dimensional.

3. The test fixture of claim 1, wherein the base portion, the first protrusion and the second protrusion are formed of a single contiguous mass of material.

4. The test fixture of claim 3, wherein the one or more first mounting surfaces comprise:
a first vertical surface extending upwardly relative to the base portion; and
a second vertical surface extending upwardly relative to the base portion, wherein the first vertical surface and the second vertical surface intersect at an apex to form an acute angle between the first vertical surface and the second vertical surface.

5. The test fixture of claim 4, wherein the one or more second mounting surfaces comprise an arcuate surface that arcs downward toward the base portion.

6. The test fixture of claim 5, wherein the base portion comprises a base surface that tapers or curves downwardly away from the first protrusion and the second protrusion.

7. The test fixture of claim 5, further comprising a housing structure that comprises a first wall having an outlet hole and a second wall that opposes the first wall and has an inlet hole, wherein the base portion is fixed and sealed to the first wall and the outlet hole is at least partially aligned with the aperture of the base portion.

8. A method of testing respirators, comprising:
sealing a respirator on a fixture, the sealing the respirator on the fixture comprising:
covering a cavity of the fixture with the respirator,
contacting the respirator to a plurality of mounting surfaces of the fixture, and
pressing an adhesive integrated as part of the respirator against the plurality of mounting surfaces of the fixture;
enclosing the respirator and the fixture within a housing structure that comprises an inlet hole and an outlet hole;
flowing an air stream through the inlet hole, through the respirator, and through the outlet hole, the air stream flowing through the inlet hole containing an aerosol challenge; and
determining that the respirator meets a testing standard based on a metric of an amount of the aerosol challenge penetrating the respirator.

9. The method of claim 8, wherein a support structure is disposed in the cavity and under the respirator.

10. The method of claim 8, wherein the aerosol challenge comprises particles of a composition selected according to the testing standard, and the testing standard is NIOSH 95.

11. The method of claim 8, wherein the sealing the respirator on the fixture further comprises:
bending the respirator about the plurality of mounting surfaces; and
after the contacting the respirator to the plurality of mounting surfaces:
pressing a first portion of the adhesive into a second portion of the adhesive.

12. The method of claim 8, wherein the plurality of mounting surfaces comprise:
a first vertical surface extending upwardly relative to a base portion of the fixture; and
a second vertical surface extending upwardly relative to the base portion, wherein the first vertical surface and the second vertical surface intersect at an apex to form an acute angle between the first vertical surface and the second vertical surface.

13. The method of claim 8, wherein the plurality of mounting surfaces comprise a base surface of a base portion of the fixture, wherein the base surface tapers or curves downwardly.

14. The method of claim 8, wherein the determining if the respirator meets the testing standard comprises:
determining an upstream particle concentration of the aerosol challenge in the flow upstream of the respirator;
determining a downstream particle concentration of the aerosol challenge in the flow downstream of the respirator; and
determining that the respirator has a particle removal efficiency equal to or greater than a a particle ratio of the downstream particle concentration relative to the upstream particle concentration.

15. The method of claim 14, wherein the determining if the respirator meets the testing standard further comprises:
determining if the particle ratio is 0.05 or less.

16. The method of claim 14, wherein the determining if the respirator meets the testing standard further comprises:
determining an upstream pressure of the aerosol stream that is upstream of the respirator;
determining a downstream pressure of the aerosol stream that is downstream of the respirator; and
determining a pressure difference between the upstream pressure and the downstream pressure.

17. The method of claim 16, wherein the determining if the respirator meets the testing standard further comprises:
determining if the pressure difference is 25 mmHg or less.

18. The method of claim 17, wherein the aerosol stream flows through the respirator at a flow rate this is within a range of 80 liters of air per minute to 90 liters of air per minute.

19. A method of testing respirators, comprising:
sealing a respirator on a fixture, the sealing the respirator on the fixture comprising:
contacting the respirator to a plurality of mounting surfaces of the fixture,
pressing an adhesive of the respirator against the plurality of mounting surfaces of the fixture, and
pressing a first portion of the adhesive into a second portion of the adhesive;
enclosing the respirator and the fixture within a housing structure that comprises an inlet hole and an outlet hole;
flowing an air stream through the inlet hole, through the respirator, and through the outlet hole, the air stream flowing through the inlet hole containing an aerosol challenge;
determining an upstream particle concentration of the aerosol challenge that is upstream of the respirator;
determining a downstream particle concentration of the aerosol challenge that is downstream of the respirator;
determining a particle ratio of the downstream particle concentration relative to the upstream particle concentration; and
determining if the particle ratio is 0.05 or less.

20. The method of claim 19, wherein each of the upstream particle concentration and the downstream particle concentration is a concentration of particles having a diameter of 0.3 microns.
